(19) United States
(12) Patent Application Publication
(10) Pub. No.: US 2013/0321495 A1
(43) Pub. Date: Dec. 5, 2013

(54) DISPLAY DEVICE

(71) Applicant: Takenori Yoshizawa, Osaka-shi (JP)

(72) Inventor: Takenori Yoshizawa, Osaka-shi (JP)

(73) Assignee: Sharp Kabushiki Kaisha, Osaka (JP)

(21) Appl. No.: 13/985,244

(22) PCT Filed: Feb. 7, 2012
(86) PCT No.: PCT/JP2012/052658

§ 371 Date: Aug. 13, 2013

(30) Foreign Application Priority Data
Feb. 14, 2011 (JP) 2011028803

(51) Int. Cl. G09G 3/34; G09G 3/36

(52) U.S. Cl. CPC G09G 3/3413; G09G 3/3648
USPC 345/691; 345/88; 345/102

(57) ABSTRACT

A liquid crystal display device (1), which is provided with a liquid crystal panel (display unit) (2) and a backlight device (backlight unit) (3), and which displays information by dividing one frame period into four sub-field periods. In the liquid crystal display device (1), a backlight control unit (23) controls a drive for lighting light-emitting diodes (4,4b) in such a manner that a first lighting period for emitting white light and a second lighting period for emitting blue light alternate in two sequential sub-field periods. A panel control unit (display control unit) (22) operates: a red pixel (Pr), a green pixel (Pg) and a transparent pixel (Pt) during the first lighting period; and the transparent pixel (Pt) during the second lighting period.

### TECHNICAL FIELD

The present invention relates to a display device and in particular to a non-radiating display device such as a liquid crystal display device.

### BACKGROUND ART

Recently, a so-called non-radiating display device that has a display unit for displaying information such as characters and images and a backlight unit for radiating a predetermined illumination light onto this display unit has been applied in practical usage. Such display devices represented by liquid crystal display devices are widely used in television receivers, monitors, portable telephones and the like as flat panel displays that are thinner and lighter than conventional cathode ray tubes.

The above-mentioned conventional display device includes a drive system for displaying red only images, green only images, and blue only images in sequence in one frame period by using light-emitting diodes (LED) of the three colors of red (R), green (G) and blue (B) as light sources and sequentially flashing the LEDs of each color in a display unit without a color filter as indicated in Patent Document 1 below. This system, which is also called a field sequential drive system, is known in the related art as a method to perform color display.

More specifically, in the conventional display device as mentioned above, a display panel prepared by providing on a pixel basis an optical shutter that serves as a shutter against light from a light source due to an electro-wetting phenomenon has been used for the display unit. Further in such a conventional display device, for each frame period, lights of red, green, blue and black, or lights of red, black, green, black, blue, and black are emitted in sequence toward the display unit, so that images of red, green and blue are displayed in sequence in one frame period.

### PRIOR ART DOCUMENTS

### Patent documents

Patent Document 1: JP 2007-219510 A

### DISCLOSURE OF INVENTION

### Problem to be Solved by the Invention

However, in the conventional display device as mentioned above, one frame period is divided into a plurality of sub-field periods so as to switch images of respective colors of red, green and blue at high speed for performing a color display. Therefore, in a case of displaying dynamic images for example, a color breakup phenomenon, which is a phenomenon where colors of the displayed images appear in a split state, may occur. As a result, the conventional display device has a problem that the display quality is degraded in a case where one frame period has been divided into a plurality of sub-field periods.

In light of the above-mentioned problem, the present invention aims to provide a display device having excellent display quality that can suppress the color breakup phenomenon even if one frame period has been divided into a plurality of sub-field periods.

### Means for Solving Problem

For achieving the above-mentioned object, a display device of the present invention is a display device having a display unit provided with a picture element composed of a set of n pixels (n is an integer larger than 2) that can be mixed to provide white color so as to display information, and a backlight unit for radiating illumination light onto the display unit. The display device further has: a display control unit for controlling a drive of the display unit on a pixel basis by use of an inputted video signal and dividing one frame period into S sub-field periods (S is an integer larger than 1) so as to allow the display unit to display information; and a backlight control unit for controlling a drive of the backlight unit. In the display unit, (n−1) pixels each provided with a color filter of any of (n−1) colors and a transparent pixel not provided with any color filter are used as the picture element. The backlight unit is provided with a plurality of light sources having at least an n-th light source that emits light of a color other than the (n−1) colors. The backlight control unit controls a drive for lighting the light sources so that in the S sub-field periods, a first lighting period for lighting the light sources so as to emit white light as the illumination light and a second lighting period for lighting the n-th light source so as to emit light of a color other than the (n−1) colors alternate in two sequential sub-field periods of the S sub-field periods, and the display control unit operates the (n−1) pixels and the transparent pixel during the first lighting period and operates the transparent pixel during the second lighting period.

In the display device configured as mentioned above, in the display unit, (n−1) pixels provided respectively with color filters of (n−1) colors and a transparent pixel not provided with any color filter are combined as a set of picture element. The backlight unit is provided with a plurality of light sources including at least an n-th light source that emits light of a color other than the (n−1) colors. Further, in the S sub-field periods, the backlight control unit controls the drive for lighting the light sources such that a first lighting period for lighting the light sources so as to emit white light as illumination light and a second lighting period for lighting the n-th light source so as to emit light of the color other than the (n−1) colors as the illumination light alternate in two sequential sub-field periods of the S sub-field periods. Further the display control unit operates (n−1) pixels and the transparent pixel during the first lighting period and operates the transparent pixel during the second lighting period. Thereby, unlike the above-mentioned conventional example, it is possible to configure a display device having excellent display quality that can suppress a color breakup phenomenon even if one frame period has been divided into a plurality of sub-field periods.

Further in the above-mentioned display device, it is preferable that in the picture element, the (n−1) pixels and the transparent pixel are modified such that a difference in transmittance between the (n−1) pixels and the transparent pixel is substantially zero.

In this case, the quantity of light that passes through the (n−1) pixels and the quantity of light that passes through the transparent pixel can be made substantially equivalent to each other. Thus, it is possible to realize a proper balance of the colors displayed by the (n−1) pixels and the transparent pixel, thereby preventing degradation of the display quality.

Further in the above-mentioned display device, in the picture element, the second lighting period in which the transparent pixel performs a display operation may be set shorter than the first lighting period in which the (n−1) pixels and the transparent pixel perform a display operation.

In this case, by adjusting the respective times of the first and second lighting periods, it is possible to realize a proper balance of the colors displayed by the (n−1) pixels and the transparent pixel, thereby preventing degradation of the display quality reliably.

Further in the above-mentioned display device, it is preferable that in the picture element, the area of the transparent pixel is set smaller than the area of any of the (n−1) pixels.

In this case, by adjusting the areas of the (n−1) pixels and the transparent pixel, it is possible to realize a proper balance of the colors displayed by the (n−1) pixels and the transparent pixel without complicating the control operation at the backlight control unit, thereby preventing degradation of the display quality reliably.

Further in the above-mentioned display device, it is preferable that in the picture element, a red pixel and a green pixels provided respectively with a red filter and a green filter are used as the (n−1) pixels; and in the backlight unit, a red light source and a green light source that respectively emit red light and green light are used as the plurality of light sources other than the n-th light source, and a blue light source that emits blue light is used as the n-th light source.

In this case, it is possible to display a full color without using a blue color filter whose transmittance is lower than those of the red color filter and a green color filter, and thus, a display device having high brightness and excellent in the efficiency for light utilization of light sources can be configured easily.

Further in the above-mentioned display device, a liquid crystal panel may be used as the display unit.

In this case, it is possible to configure a liquid crystal display device having excellent display quality that can suppress the color breakup phenomenon even if one frame period has been divided into a plurality of sub-field periods.

Further in the above-mentioned display device, the light sources may be provided to the backlight unit so as to face the display unit.

In this case, illumination light from the direct type backlight unit is radiated onto the display unit.

Further in the above-mentioned display device, the backlight unit may be provided with a light guide into which light from the light sources enters and that emits the incident light toward the display unit.

In this case, illumination light from the edge-light type backlight unit is radiated onto the display unit.

Further in the above-mentioned display device, it is preferable that light-emitting diodes are used as the light sources.

In this case, an energy-saving and eco-friendly display device can be configured easily.

### Effects of the Invention

According to the present invention, it is possible to provide a display device having excellent display quality that can suppress a color breakup phenomenon even if one frame period has been divided into a plurality of sub-field periods.

### BRIEF DESCRIPTION OF DRAWINGS

FIG. 1 describes principal components of a liquid crystal display device according to a first embodiment of the present invention.

FIG. 2 describes principal components of a liquid crystal panel shown in FIG. 1.

FIG. 3A is a plan view showing a specific configuration example of a picture element provided to the liquid crystal panel, and FIG. 3B is a cross-sectional view for illustrating the schematic structure of the picture element.

FIG. 4 is a plan view showing principal components of the backlight unit shown in FIG. 1.

FIG. 5 is a block diagram showing a specific configuration example of the controller shown in FIG. 2.

FIG. 6 is composed of diagrams for illustrating an operation example at the liquid crystal display device: FIGS. 6A-6D are diagrams respectively for illustrating specific operations during the four sub-field periods.

FIG. 7 is composed of diagrams for illustrating a specific lighting operation at the backlight unit: FIGS. 7A-7D are diagrams for respectively illustrating specific lighting periods during the abovementioned four sub-field periods.

FIG. 8A is a plan view showing a specific configuration example of a picture element provided to a liquid crystal panel of a liquid crystal display device according to a second embodiment of the present invention, and FIG. 8B is a cross-sectional view for illustrating the schematic structure of the picture element shown in FIG. 8A.

FIG. 9 is composed of diagrams for illustrating a specific lighting operation at a backlight unit of the liquid crystal display device according to the second embodiment of the present invention: FIGS. 9A-9D are diagrams for respectively illustrating specific lighting periods in the four sub-field periods.

FIG. 10 describes principal components of a liquid crystal display device according to a third embodiment of the present invention.

FIG. 11 is a plan view showing principal components of a backlight unit shown in FIG. 10.

### DESCRIPTION OF THE INVENTION

The following description refers to embodiments of a display device of the present invention with reference to the drawings. Note that the following description provides an example in which the present invention is applied to a transmissive liquid crystal display device. Also, the dimensions of constituent elements illustrated in the drawings are not precise representations of the actual dimensions or dimensional ratios thereof.

### First Embodiment

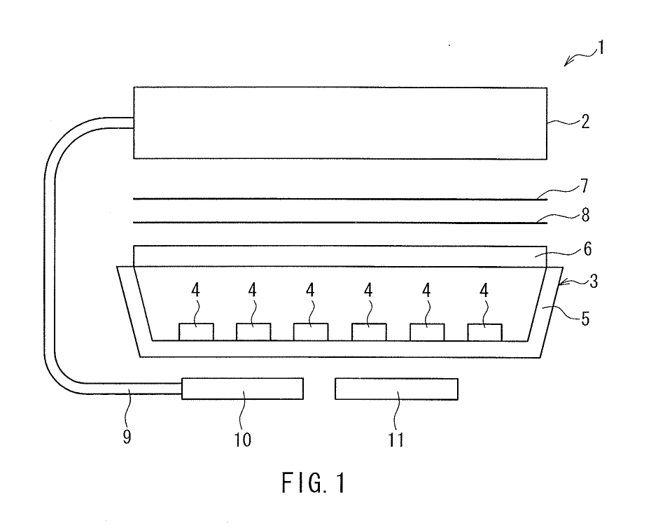

FIG. 1 describes principal components of a liquid crystal display device according to a first embodiment of the present invention. In FIG. 1, a liquid crystal display device 1 is provided with a liquid crystal panel 2 as a display unit for displaying information, and a backlight device 3 as a backlight unit that is disposed on an non-display surface (the bottom in the drawing) of the liquid crystal panel 2 so as to radiate illumination light onto the liquid crystal panel 2. The liquid crystal panel 2 and the backlight device 3 are integrated as a transmissive liquid crystal display device 1.

In the backlight device 3, as mentioned below in detail, a plurality of light-emitting diodes as light sources are contained in a chassis 5. These light-emitting diodes 4 are disposed to face the liquid crystal panel 2 via a diffusion plate 6, a prism sheet 8, and a polarizing sheet 7.

In the liquid crystal display device 1, a below-mentioned liquid crystal layer included in the liquid crystal panel 2 is connected to a drive circuit 10 via an FPC (Flexible Printed Circuit) 9, and the drive circuit 10 is configured to drive the liquid crystal layer on a pixel basis. Further, an inverter circuit 11 is disposed in the vicinity of the drive circuit 10. This inverter circuit 11 is configured to drive and light the plural light-emitting diodes 4.

Further in the liquid crystal display device 1 of the present embodiment, as mentioned below in detail, one frame period (1 TV field period) is divided into four sub-field periods so as to display information. Here, each of the four sub-field periods corresponds to a ¼ frame period, and they are configured as periods of time equal to each other.

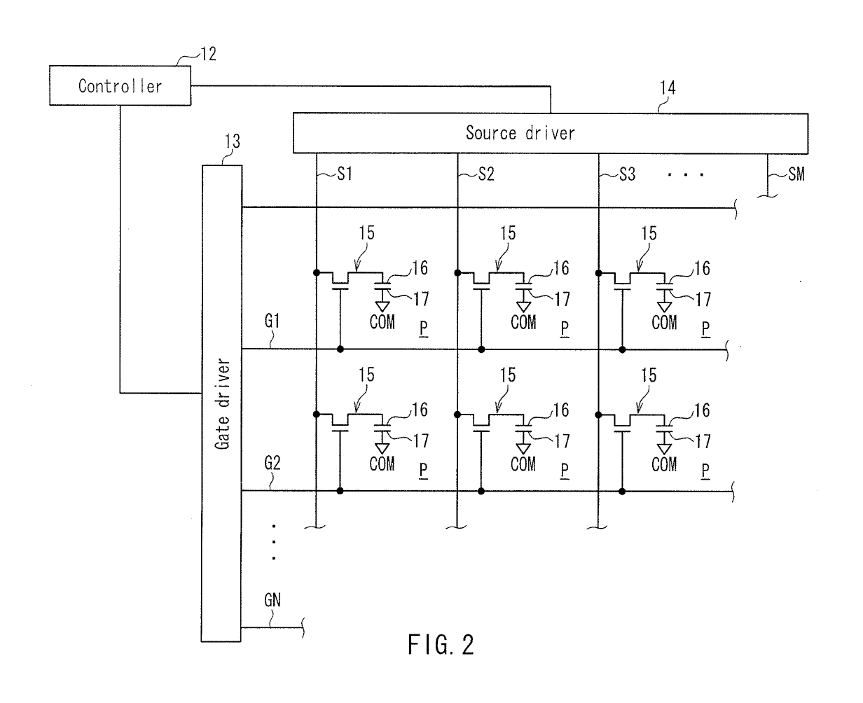

Next, with reference also to FIGS. 2-5, the liquid crystal panel 2 and the backlight device 3 of the present embodiment will be specified.

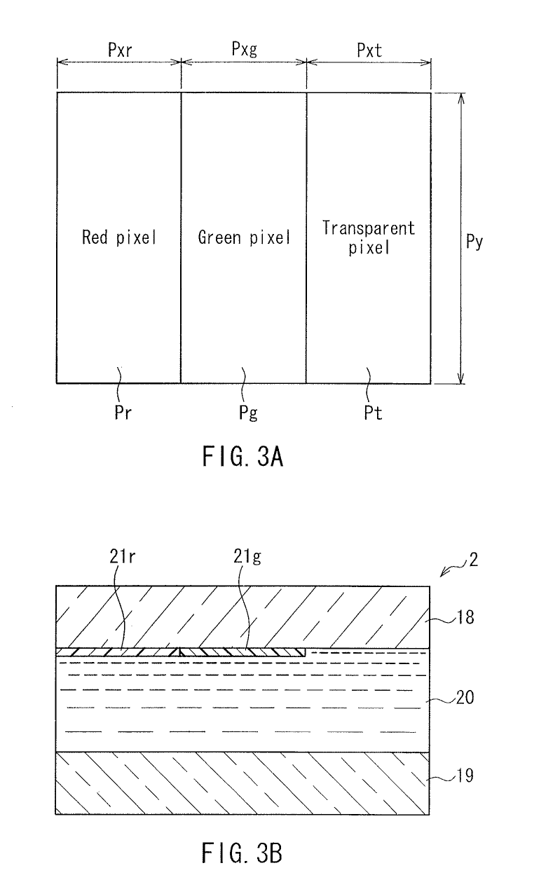

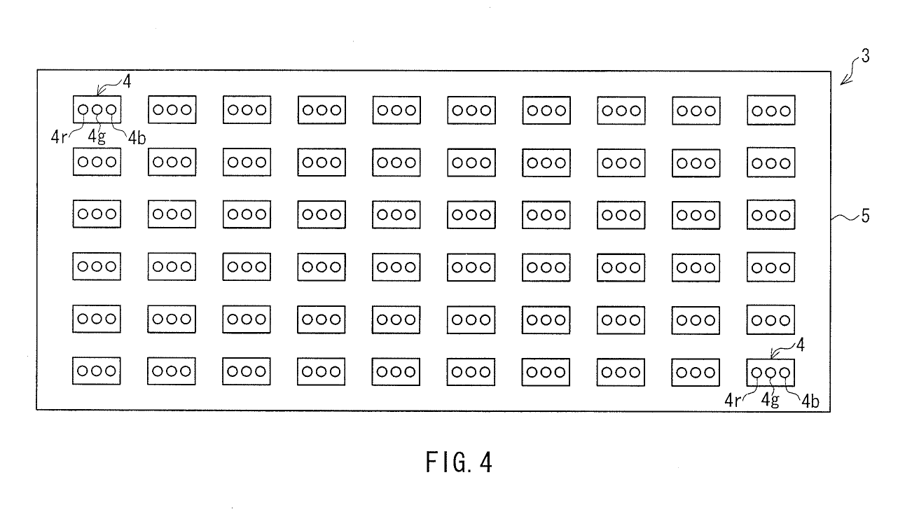

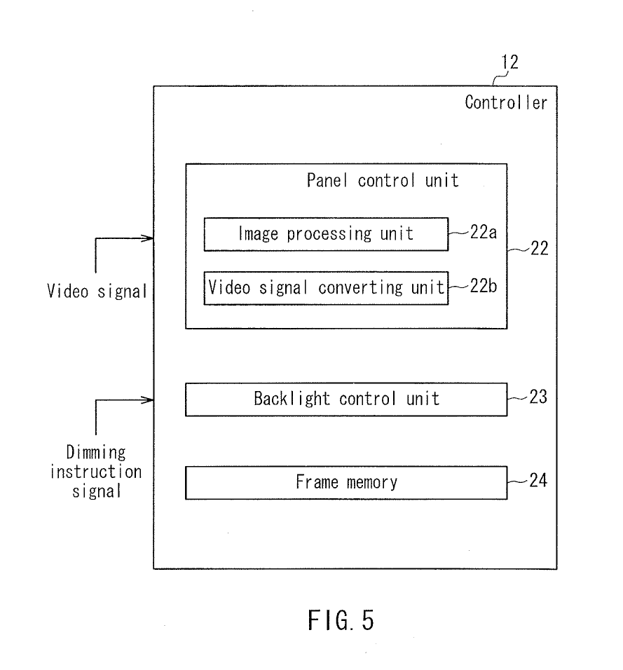

FIG. 2 describes the principal components of the liquid crystal panel shown in FIG. 1. FIG. 3A is a plan view showing a specific configuration example of a picture element provided to the abovementioned liquid crystal panel. FIG. 3B is a cross-sectional view for illustrating the schematic structure of the abovementioned picture element. FIG. 4 is a plan view showing principal components of the backlight device shown in FIG. 1. And FIG. 5 is a block diagram showing a specific configuration example of the controller shown in FIG. 2.

First, the structures of the liquid crystal panel 2 and the picture element provided to the liquid crystal panel 2 will be specified with reference to FIGS. 2 and 3.

In FIG. 2, the liquid crystal display device 1 of the present embodiment is provided with a controller 12 as a control device into which video signals and dimming instruction signals are inputted from the outside (see also FIG. 5), and the controller 12 controls the respective drives of the liquid crystal panel 2 and the backlight device 3. As shown in FIG. 2, the controller 12 is further connected to a gate driver 13 and a source driver 14 of the liquid crystal panel 2 included in the drive circuit 10.

The gate driver 13 and the source driver 14 are drive circuits that drive on a pixel basis a plurality of pixels P provided in the liquid crystal panel 2. A plurality of gate lines G1 to GN (N is an integer larger than 1) and a plurality of source lines S1 to SM (M is an integer larger than 1) are connected respectively to the gate driver 13 and the source driver 14. The gate lines G1 to GN and the source lines S1 to SM are provided in a matrix arrangement, and regions of the above-mentioned plurality of pixels P are formed in regions delineated by the matrix arrangement.

Gates of switching elements 15, that are constituted by, for example, thin-film transistors and are provided in each pixel P, are connected to each of the gate lines G1 to GN. Sources of the switching elements 15 are connected to each of the source lines S1 to SM. Drains of the switching elements 15 are connected to pixel electrodes 16 provided in each pixel P. The pixels P are configured so that common electrodes 17 face the pixel electrodes 16 with a liquid crystal layer provided in the liquid crystal panel 2 interposed therebetween.

The liquid crystal panel 2 is configured so that control signals from the abovementioned controller 12 are inputted to the source driver 14. The source driver 14 appropriately outputs voltage signals corresponding to the inputted control signals to the source lines S1 to SM. The gate driver 13 sequentially outputs gate signals that turn on the gates of the corresponding switching elements 15 to the gate lines G1 to GN on the basis of the control signals from the controller 12. As a result, the transmittance of each pixel P is changed and the input images are displayed on the liquid crystal panel 2 for displaying the input images corresponding to the inputted image signals.

The liquid crystal panel 2 of the present embodiment is provided with a picture element composed of a set of three pixels (n pixels (n is an integer larger than 2)) that can be mixed to provide white color. Specifically, as shown in FIG. 3A, the picture element of the liquid crystal panel 2 is composed of a red pixel Pr, a green pixel Pg and a transparent pixel Pt. The red pixel Pr, the green pixel Pg and the transparent pixel Pt are provided in sequence along the abovementioned source lines S1 to SM. Further, the red pixel Pr and the green pixel Pg compose (n−1) pixels.

Furthermore, as shown in FIG. 3B, the red pixel Pr and the green pixel Pg are provided respectively with a red color filter 21r and a green color filter 21g, while the transparent pixel Pt is not provided with any color filter. Namely, as shown in FIG. 3B, the liquid crystal panel 2 includes a color filter substrate 18 provided with the color filters 21r and 21g, an active matrix substrate 19 provided with the abovementioned switching elements 15 and the like, and the abovementioned liquid crystal layer 20 interposed between the color filter substrate 18 and the active matrix substrate 19. The red pixel Pr, the green pixel Pg and the transparent pixel Pt are formed in sequence from the left hand to the right hand in FIG. 3B.

The red pixel Pr, the green pixel Pg and the transparent pixel Pt have a vertical dimension Py in FIG. 3A equivalent to each other. Furthermore, the red pixel Pr, the green pixel Pg and the transparent pixel Pt have horizontal dimensions Pxr, Pxg and Pxt in FIG. 3A, which are also equivalent to each other. Namely, in the picture element of the present embodiment, the red pixel Pr, the green pixel Pg and the transparent pixel Pt are configured to have areas equivalent to each other.

The red pixel Pr, the green pixel Pg and the transparent pixel Pt are to be irradiated with illumination light from the backlight device 3 provided closer to the active matrix substrate 19. Further, as mentioned in detail below, the backlight device 3 is configured to radiate white light and blue light alternately as the abovementioned illumination light. And the red pixel Pr, the green pixel Pg and the transparent pixel Pt are configured to display information of red, green and white colors respectively in a case of radiating white light, and only the transparent pixel Pt displays information of blue color in a case of radiating blue light.

Further in the liquid crystal panel 2 of the present embodiment, the time for radiating the blue light is set shorter than the time for radiating the white light, so that the quantity of light passing through the red pixel Pr and the green pixel Pg is substantially equivalent to the quantity of light passing through the transparent pixel Pt (the details are mentioned later).

Next, the backlight device 3 of the present embodiment will be specified below with reference to FIG. 4.

As shown in FIG. 4, in the backlight device 3, totally sixty light-emitting diodes, which are provided as six rows and ten columns respectively in parallel in the transverse and longitudinal directions on the display surface of the liquid crystal panel 2, are used. Further in the backlight device 3, the light-emitting diodes 4 are provided facing the liquid crystal panel (display unit) 2 so as to configure a direct type backlight device.

Each of the plurality of light-emitting diodes 4 is used with a so-called three-in-one (3in1) type in which red, green, and blue light-emitting diodes 4r, 4g, and 4b that respectively emit light of the three colors of red (R), green (G) and blue (B) are integrally formed, for example. In other words, the light sources with the plurality of colors that can be mixed to form white light are used in the backlight device 3. Among these red, green and blue light-emitting diodes 4r, 4g and 4b, the red and green light-emitting diodes 4r, 4g configure a plurality of light sources other than the n-th light source, while the blue light-emitting diode 4b configures the n-th light source. In the backlight device 3, as mentioned below in detail, in one frame period, a first lighting period for emitting white light as the illumination light and a second lighting period for emitting light of a color other than the above-mentioned (n−1) colors, namely, blue light as the illumination light will alternate in two sequential sub-field periods of four sub-fields periods.

Next, the controller 12 will be specified below with reference to FIG. 5.

As shown in FIG. 5, the controller 12 is provided with a panel control unit 22 as a display control unit, a backlight control unit 23 for controlling a drive of the backlight device 3, and a frame memory 24 configured to be capable of storing display data on a frame basis included in video signals inputted via an antenna (not shown) or the like. For this panel control unit 22, for example ASIC (Application Specific Integrated Circuit) is used, so that the panel control unit 22 can perform a predetermined arithmetic processing at high speed with respect to the abovementioned display data to be serially stored on the frame memory 24.

Further, the panel control unit 22 is provided with an image processing unit 22a and a video signal converting unit 22b so as to control a drive of the liquid crystal panel 2 on a pixel basis by use of the inputted video signals. The panel control unit 22 is configured to calculate the video signals in each of the sub-field periods from the inputted video signals on the basis of the illumination light for each sub-field period among S sub-field periods (S is an integer larger than 1), for example, the four sub-field periods, thereby controlling the drive of the liquid crystal panel 2.

The backlight control unit 23 controls the drive for lighting the light-emitting diodes 4r, 4g and 4b such that in the four sub-field periods, a first lighting period for lighting the light-emitting diodes 4r, 4g and 4b (the plurality of light sources) so as to emit white light as illumination light toward the liquid crystal panel 2 and a second lighting period for lighting the light-emitting diode 4b (the n-th light source) so as to emit blue (a color other than the (n−1) colors) light as illumination light toward the liquid crystal panel 2 alternate in two sequential sub-field periods of four sub-field periods.

The backlight control unit 23 is configured to control the drive for lighting the light-emitting diodes 4 so that the second lighting period is shorter than the first lighting period.

The panel control unit 22 is configured to operate the red and green pixels Pr, Pg ((n−1) pixels) and the transparent pixel Pt during the first lighting period and operate the transparent pixel Pt during the second lighting period.

The image processing unit 22a is configured to output instruction signals such as the abovementioned control signal to the gate driver 13 and the source driver 14 in accordance with the inputted video signals. The image processing unit 22a determines on a pixel basis a value of the data signal (gradient voltage) on the basis of the video signals after converted by the video signal converting unit 22b and outputs the value included in the instruction signal to the source driver 14.

The video signal converting unit 22b is configured to generate the respective video signals on a pixel basis during the four sub-field periods included in one frame period for displaying one image on the liquid crystal panel 2. Namely, the video signal converting unit 22b converts the inputted video signals to respective video signals in the four sub-field periods on the basis of the inputted video signals and the illumination light in the respective four sub-field periods.

Specifically, the video signal converting unit 22b acquires data of the transmittances of respective pixels from the display data included in the video signals for one frame held by the frame memory 24. And the video signal converting unit 22b determines the respective transmittances of the corresponding pixels during the four sub-field periods by use of the thus acquired transmittance of the respective pixels in accordance with a predetermined algorithm considering the colors (i.e., white and blue) of the illumination light during the first and second lighting periods. Thereby, at the respective pixels, the respective transmittances during the four sub-field periods are converted appropriately in accordance with the inputted video signals and the color of the illumination light from the backlight device 3.

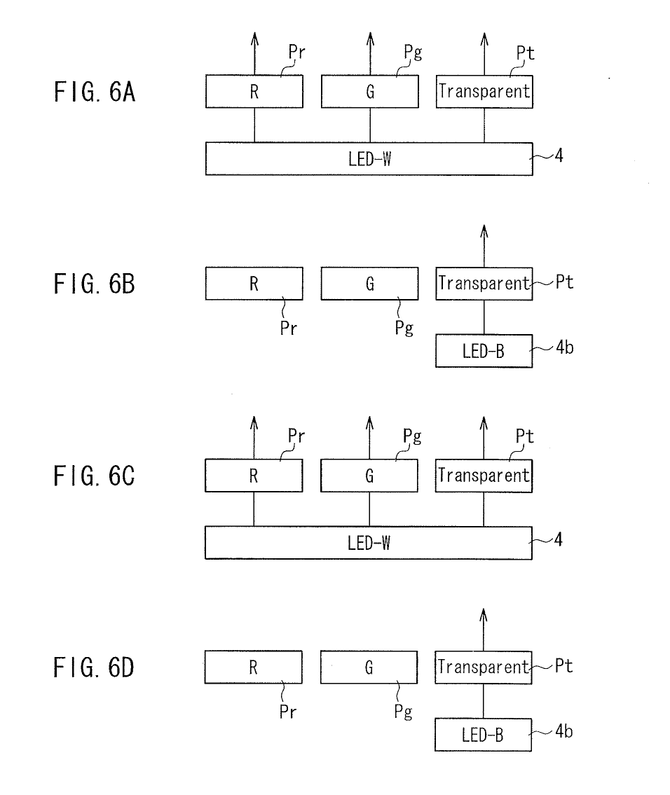

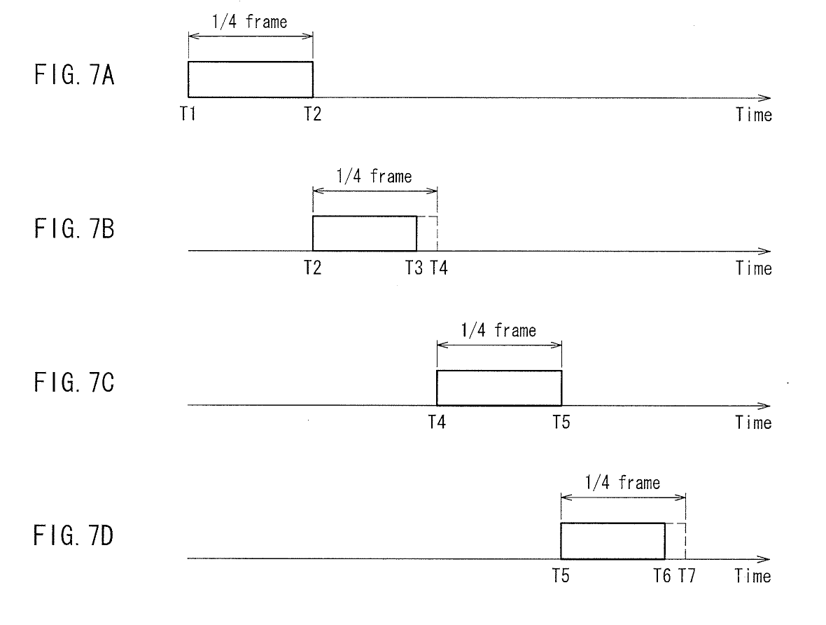

The operations of the liquid crystal display device 1 of the present embodiment will be specified further with reference also to FIGS. 6 and 7.

FIG. 6 describes an operation example at the abovementioned liquid crystal display device. Namely, FIGS. 6A to 6D describe respectively the specific operations during the four sub-field periods. FIG. 7 describes a specific lighting operation at the backlight device. Namely, FIGS. 7A to 7D describe respectively the specific lighting periods during the four sub-field periods.

As shown in FIG. 6A, in the liquid crystal display device 1 of the present embodiment, the first lighting period proceeds in the first sub-field period of the four sub-field periods. Namely, in this first sub-field period, all of the light-emitting diodes 4r, 4g, 4b of RGB are lit and thus white light is radiated as illumination light from the backlight device 3 onto the liquid crystal panel 2. And at the liquid crystal panel 2, all of the pixels P, namely, the red and green pixels Pr, Pg and the transparent pixel Pt are driven to display information.

Next, as shown in FIG. 6B, in the second sub-field period, the second lighting period proceeds. Namely, in this second sub-field period, only the blue light-emitting diode 4b is lit, and thereby blue light is radiated as the illumination light from the backlight device 3 onto the liquid crystal panel 2. And at the liquid crystal panel 2, only the transparent pixel Pt is driven to display information.

Next, as shown in FIG. 6C, in the third sub-field period, the first lighting period proceeds. Namely, in this third sub-field period, all of the light-emitting diodes 4r, 4g and 4b of RGB are lit and thus white light is radiated as illumination light from the backlight device 3 onto the liquid crystal panel 2. And at the liquid crystal panel 2, all of the pixels P, i.e., red and green pixels Pr, Pg and the transparent pixel Pt are driven to display information.

Next, as shown in FIG. 6D, in the fourth sub-field period, the second lighting period proceeds. Namely, in this fourth sub-field period, only the blue light-emitting diode 4b is lit and blue light is radiated as illumination light from the backlight device 3 onto the liquid crystal panel 2. And at the liquid crystal panel 2, only the transparent pixel Pt is driven to display information.

Further as shown in FIG. 7A, the first sub-field period proceeds from a time point T1 to a time point T2. Since this sub-field period corresponds to the first lighting period, during the period from the time point T1 to the time point T2, white light is emitted from the backlight device 3 toward the liquid crystal panel 2.

Further, as shown in FIG. 7B, the second sub-field period proceeds from the time point T2 to a time point T4. In this sub-field period, the second lighting period proceeds during a period shorter than the sub-field period, e.g., from the time point T2 to a time point T3, so that blue light is emitted from the backlight device 3 toward the liquid crystal panel 2.

Further as shown in FIG. 7C, the third sub-field period proceeds from the time point T4 to a time point T5. Since this sub-field period corresponds to the first lighting period, during the period from the time point T4 to the time point T5, white light is emitted from the backlight device 3 toward the liquid crystal panel 2.

Further, as shown in FIG. 7D, the fourth sub-field period proceeds from the time point T5 to a time point T7. In this sub-field period, the second lighting period proceeds during a period shorter than the sub-field period, e.g., from the time point T5 to a time point T6, so that blue light is emitted from the backlight device 3 toward the liquid crystal panel 2.

In the four sub-field periods, the time for the first and second lighting periods and also the time for the time difference between these first and second lighting periods (i.e., the sum of the time from the time point T3 to the time point T4 and the time from the time point T6 to the time point T7) are determined such that in one frame period, the quantity of light passing through the red pixel Pr and the green pixel Pg and the quantity of light passing through the transparent pixel Pt will be substantially equivalent to each other. Namely, since the light is absorbed by the color filters 21r and 21g at the red and green pixels Pr and Pg, brightness of the red and green lights deteriorates in comparison with the brightness of blue light passing through the transparent pixel Pt. Therefore, as mentioned above, by adjusting the times for the first and second lighting periods, it is possible to realize a proper balance in the brightness for the red, green and blue lights.

In the thus configured liquid crystal display device 1 of the present embodiment, at the liquid crystal panel (display unit) 2, red and green pixels ((n−1) pixels) Pr and Pg provided with red and green ((n−1) colors) color filters 21r and 21g, and a transparent pixel Pt not provided with any color filter are configured as a set of picture element. The backlight device (backlight unit) 3 is provided with red and green light-emitting diodes (plurality of light sources other than an n-th light source) 4r, 4g respectively emitting red light and green light, and a blue light-emitting diode (an n-th light source) 4b emitting blue (a color other than (n−1) colors) light.

Further in the liquid crystal display device 1 of the present embodiment, in the four sub-field periods, the backlight control unit 23 controls the drive for lighting the light-emitting diodes 4r, 4g and 4b such that the first lighting period for lighting the light-emitting diodes 4r, 4g and 4b so as to emit white light as illumination light and the second lighting period for lighting the light-emitting diode 4b so as to emit blue light as illumination light alternate in two sequential sub-field periods of four sub-field periods. And the panel control unit (display control unit) 22 operates the red and green pixels Pr and Pg and the transparent pixel Pt during the first lighting period, and operates the transparent pixel Pt during the second lighting period. Thereby, unlike the abovementioned conventional example, the present embodiment can provide a liquid crystal display device (display device) 1 having excellent display quality that can suppress a color breakup phenomenon even if one frame period has been divided into a plurality of sub-field periods.

Since the liquid crystal display device 1 of the present embodiment is provided with a transparent pixel Pt, it is possible to improve the efficiency in utilization of the light of the respective colors of white and blue, and thus the brightness of the respective colors of white and blue can be enhanced easily.

In the liquid crystal display device 1 of the present embodiment, the time of the second lighting period in which the transparent pixel Pt performs a display operation is set shorter than the time of the first lighting period in which the red and green pixels Pr, Pg and the transparent pixel Pt perform a display operation. Thereby, in the liquid crystal display device 1 of the present embodiment, the quantity of light passing through the red and green pixels Pr and Pg and the quantity of light passing through the transparent pixel Pt can be substantially equivalent to each other, and thus it is possible to realize a proper balance of the colors displayed by the red and green pixels Pr, Pg and the transparent pixel Pt. As a result, degradation of the display quality can be prevented reliably.

### Second Embodiment

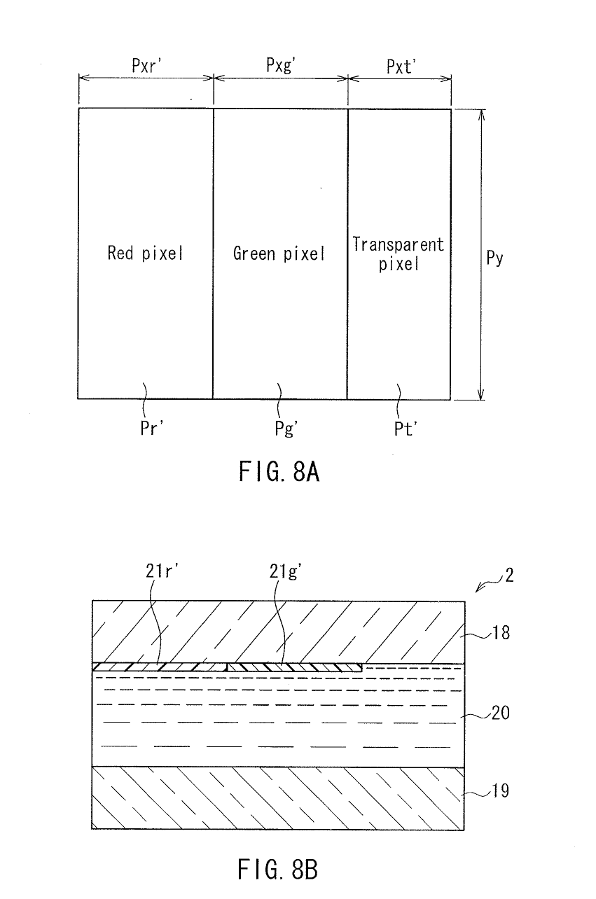

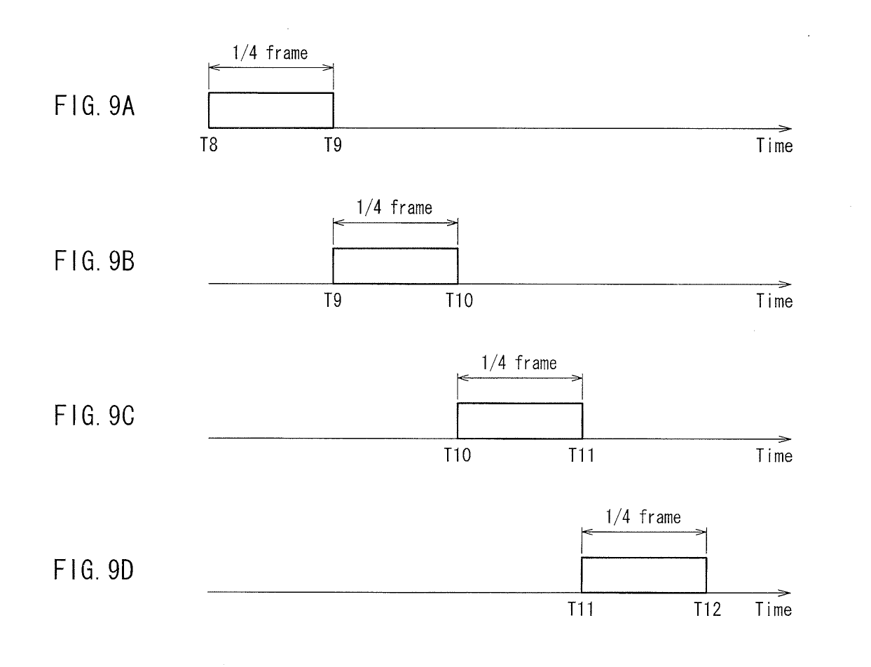

FIG. 8A is a plan view showing a specific configuration example of a picture element provided to a liquid crystal panel of a liquid crystal display device according to a second embodiment of the present invention; and FIG. 8B is a cross-sectional view for illustrating the schematic structure of the picture element shown in FIG. 8A. FIG. 9 describes a specific lighting operation of a backlight device of the liquid crystal display device according to the second embodiment. FIGS. 9A-9D are diagrams for respectively illustrating specific lighting periods during the four sub-field periods. In the drawings, the present embodiment is differentiated from the abovementioned first embodiment mainly in that the times of the first and second lighting periods are set equivalent to each other and that the area of the transparent pixel in the picture element is made smaller than the area of any of the red and green pixels. In the following description of embodiment, the same reference numerals may be assigned to the same components as those of the first embodiment in order to avoid the duplication of explanations.

Namely, as shown in FIGS. 8A and 8B, in the picture element of the liquid crystal display device 1 of the present embodiment, the area of the transparent pixel Pt′ is set smaller than the area of any of the red and green pixels Pr′ and Pg′. Specifically, the red pixel Pr′, the green pixel Pg′ and the transparent pixel Pt′ have a vertical dimension Py′ in FIG. 8A equivalent to each other. On the other hand, for the red pixel Pr′, the green pixel Pg′ and the transparent pixel Pt′, in comparison with the horizontal dimensions Pxr′ and Pxg′ in FIG. 8A, the dimension Pxt′ in the same direction is set smaller. Namely, the red and green color filters 21r ′ and 21g ′ used in the present embodiment have areas larger than those of the color filters 21r, 21g shown in FIG. 3B.

Further, as mentioned above, since the area of the transparent pixel Pt′ is set smaller than the area of any of the red and green pixels Pr′ and Pg′, the quantity of light passing through the transparent pixel Pt′ can be made substantially equivalent to the quantity of light passing through any of the red and green pixels Pr′ and Pg′.

Further in the present embodiment, as shown in FIGS. 9A-9D, the backlight control unit 23 equalizes the first and the second lighting periods. Namely, as shown in FIG. 9A, the first sub-field period proceeds from a time point T8 to a time point T9. Since this sub-field period corresponds to the first lighting period, during the period from the time point T8 to the time point T9, white light is emitted from the backlight device 3 toward the liquid crystal panel 2.

Further as shown in FIG. 9B, the second sub-field period proceeds from the time point T9 to a time point T10. Since this sub-field period corresponds to the second lighting period, during the period from the time point T9 to the time point T10, blue light is emitted from the backlight device 3 toward the liquid crystal panel 2.

Further as shown in FIG. 9C, the third sub-field period proceeds from the time point T10 to a time point T11. Since this sub-field period corresponds to the first lighting period, during the period from the time point T10 to the time point T11, white light is emitted from the backlight device 3 toward the liquid crystal panel 2.

Further as shown in FIG. 9D, the fourth sub-field period proceeds from the time point T11 to a time point T12. Since this sub-field period corresponds to the second lighting period, during the period from the time point T11 to the time point T12, blue light is emitted from the backlight device 3 toward the liquid crystal panel 2.

Due to the abovementioned configuration, the present embodiment can provide effects similar to those of the abovementioned first embodiment Further in the present embodiment, the area of the transparent pixel Pt′ is set smaller than the area of any of the red and green pixels Pr′ and Pg. Thereby in the present invention, it is possible to equalize substantially the quantity of light passing through the red and green pixels Pr′ and Pg to the quantity of light passing through the transparent pixel Pt′ without complicating the control operation at the backlight control unit 23. As a result, it is possible to realize a proper balance of colors displayed by the red and green pixels Pr′, Pg and the transparent pixel Pt′, thereby preventing degradation of the display quality reliably.

### Third Embodiment

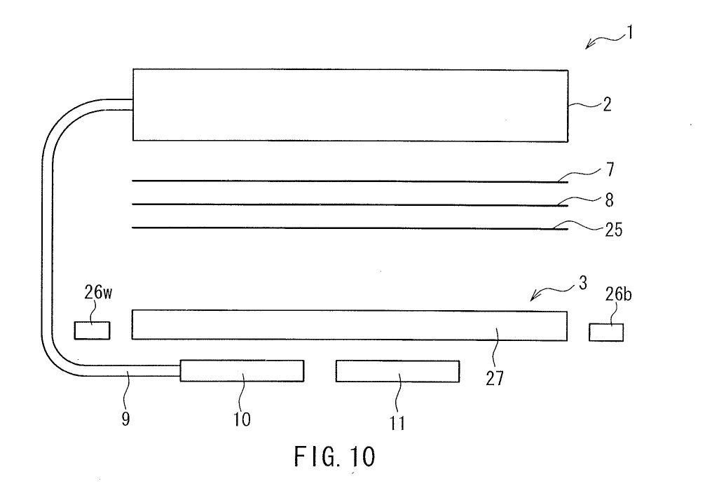

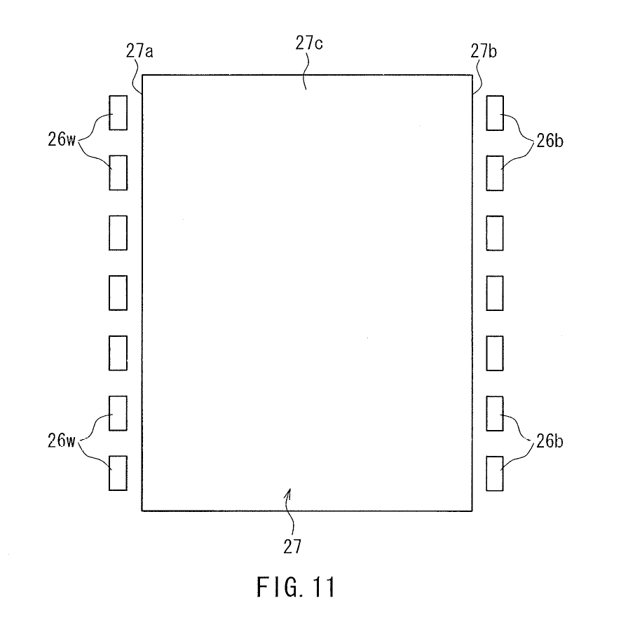

FIG. 10 describes principal components of a liquid crystal display device according to a third embodiment of the present invention. FIG. 11 is a plan view showing principal components of the backlight device shown in FIG. 10. In the drawings, the present embodiment is differentiated from the abovementioned first embodiment mainly in that an edge-light type backlight device having a light guide is used. In the following description of embodiment, the same reference numerals may be assigned to the same components as those of the first embodiment in order to avoid the duplication of explanations.

Namely, as shown in FIG. 10, in a liquid crystal display device 1 of the present embodiment, an edge-light type backlight device (backlight unit) 3 is used. Specifically, the backlight unit 3 is provided with a light guide 27 through which white light from white light-emitting diodes 26w and blue light from blue light-emitting diodes 26b enter. And in the liquid crystal display device 1 of the present embodiment, light from the light guide 27 is radiated onto the liquid crystal panel 2 via a diffusion sheet 25, a prism sheet 8, and a polarizing sheet 7.

Specifically, as illustrated in FIG. 11, for example seven light-emitting diodes 26w are provided oppositely on one longer side face of the light guide 27, thereby the side face composes an incidence light surface 27a through which the white light from the light-emitting diodes 26w enters. Further, on the other longer side of the light guide 27, for example seven light-emitting diodes 26b are provided oppositely. The side face composes an incidence light surface 27h through which the blue light from the light-emitting diodes 28b enters.

And in the light guide 27, during the first lighting period included in the sub-field periods, only the white light from the light-emitting diodes 26w is allowed to enter, so that white light as illumination light is radiated from the whole surface of a light-emitting surface 27c onto the liquid crystal panel 2.

In the light guide 27, during the second lighting period included in the sub-field periods, only the blue light from the light-emitting diodes 26b is allowed to enter, so that blue light as illumination light is radiated from the whole surface of a light-emitting surface 27c onto the liquid crystal panel 2.

With the abovementioned configuration, the present embodiment can provide effects similar to those of the abovementioned first embodiment. Further in the present embodiment, since a light guide 27 through which the light from the light-emitting diodes (light sources) 26w and 26b enter and that emits the incident light toward the liquid crystal panel (display unit) is provided, the liquid crystal panel 2 is irradiated with the illumination light from the edge-light type backlight device (backlight unit) 3.

The above configurations are all examples and are not intended to limit the embodiments. The technical scope of the present invention is defined by the scope of the claims and any modifications to the elements described therein or their equivalents are included within the technical scope of the present invention.

For example, although the present invention has been described as applicable to a transmissive liquid crystal display device, the display device of the present invention is not limited as such and may be applicable to various types of non-radiating display devices that use light from a light source to display information. Specifically, the display device of the present invention may be appropriately used in a projection type display device such as a rear-projection device that uses a semi-transmissive liquid crystal display device or the abovementioned liquid crystal panel in a light bulb. Further, the present invention can be applied also to various display devices where the liquid crystal panels as the display units are replaced by any other display elements such as a display element using an electro-wetting phenomenon.

Although the above description refers to an example in which a light-emitting diode is used as a light source, the light source of the present invention is not limited to this type and, for example, a discharge tube such as a cold-cathode fluorescent tube or a hot-cathode fluorescent tube, a light-emitting element such as an organic or a inorganic electronic luminance (EL) element, or a light-emitting device such as a plasma display panel (PDP) may be used in the light source.

As described in the above embodiments however, the use of a light-emitting diode for the light source is preferable since an energy-saving and eco-friendly display device may be configured easily.

Although the above description refers to a case where one frame period is divided into four sub-field periods, the present invention is not limited to this example as long as one frame period is divided into S (S is an integer larger than 1) sub-field periods so as to display information. Specifically for example, it is also possible to use two sub-field periods for proceeding the first and second lighting periods each once or to use three or more sub-field periods including black color. The present invention can be applied to any plural sequential sub-field periods that compose one frame period (1 TV field period).

The above description refers to a case where red and green pixels respectively provided with red and green color filters are used as the (n−1) pixels; red and green light-emitting diodes that respectively emit red light and green light are used as a plurality of light sources other than an n-th light source; and a blue light-emitting diode that emits blue light is used as the n-th light source. However, the present invention is not limited to this example as long as n (n is an integer larger than 2) pixels that can be mixed to provide white color are provided, and at the same time, (n−1) pixels provided respectively with color filters of (n−1) colors and a transparent pixel not provided with any color filter are composed as a set of picture element, and the backlight unit is provided with a plurality of light sources including at least an n-th light source that emits light of a color other than (n−1) colors. Specifically, for example, it is possible that red and blue pixels provided respectively with red and blue color filters are used, and at the same time, red and blue light sources that respectively emit red and blue light are used as a plurality of light sources other than the n-th light source, and a green light source that emits green light is used also as the n-th light source.

The first and second embodiments respectively refer to a configuration for using a so-called three-in-one (3in1) type light-emitting diode formed integrally with red, green and blue light-emitting diodes that respectively emit light of red (R), green (G), and blue (B) and, during the first lighting period, all of the light-emitting diodes of red, green and blue are lit to emit white light as illumination light, and during the second lighting period, only the blue light-emitting diode is lit to emit blue light as illumination light. However, the present invention is not limited to this example, but it may also refer to a configuration where for example white light-emitting diodes and blue light-emitting diodes are arranged alternately inside a chassis so that in the first and second lighting periods, the white and blue light-emitting diodes are lit respectively.

Alternatively for example, it may refer to a configuration where a blue pixel provided with a blue color filter, a yellow pixel provided with a color filter of a color other than RGB (e.g., yellow) and a transparent pixel are used, and where the red, green and white light sources that emit respectively red, green and white light are lit respectively in sequential three sub-field periods.

However, it is preferable to employ the respective embodiments as mentioned above where red and green pixels are used and also where red and green light sources are used as the first to the (n−1)th light sources and a blue light source is used as the n-th light source, since it enables to perform a full-color display without using a blue color filter whose transmittance is lower than those of the red and green color filters, thereby enabling to provide easily a display device having a high brightness and excellent efficiency in light utilization of the light sources.

The first embodiment refers to a case where the time of the second lighting period is set shorter than the time of the first lighting period, while the second embodiment refers to a case where the area of the transparent pixel is made smaller than the area of any of the red and green pixels. However, the present invention is not limited in particular as long as the (n−1) pixels and the transparent pixel are modified such that the difference in transmittance between the (n−1) pixels and the transparent pixel is substantially zero. Namely, in the present invention, by modifying the (n−1) pixels and the transparent pixel such that the difference in the transmittance will be substantially zero, the quantity of light passing through the (n−1) pixels and the quantity of light passing through the transparent pixel can be made substantially equivalent to each other, and thus it is possible to realize a proper balance of the colors displayed by the (n−1) pixels and the transparent pixel, thereby preventing degradation of the display quality. Specifically, the first and second embodiments may be combined with each other.

### INDUSTRIAL APPLICABILITY

The present invention can be applied preferably to a display device having excellent display quality that can suppress a color breakup phenomenon even if one frame period has been divided into a plurality of sub-field periods

### EXPLANATION OF LETTERS AND NUMERALS

1 liquid crystal display device

2 liquid crystal panel (display unit)

3 backlight device (backlight unit)

4 light-emitting diode (light source)

4r red light-emitting diode ((plural) light sources)

4g green light-emitting diode ((plural) light sources)

4b blue light-emitting diode ((n-th) light source)

21r,21r ′ red color filter ((n−1) color filters)

21g,21g ′ green color filter ((n−1) color filters)

22 panel control unit (display control unit)

23 backlight control unit

26w white light-emitting diode ((plural) light sources)

26b blue light-emitting diode ((n-th) light source)

27 light guide

Pr,Pr′ red pixel ((n−1) pixels, picture element)

Pg,Pg′ green pixel ((n−1) pixels, picture element)

Pt,Pt′ transparent pixel (picture element)

1. A display device comprising a display unit provided with a picture element composed of a set of pixels of n (n is an integer larger than 2) that can be mixed to provide white color so as to display information, and a backlight unit for radiating illumination light onto the display unit,
the display device further comprising:
a display control unit for controlling a drive of the display unit on a pixel basis by use of an inputted video signal and dividing one frame period into S sub-field periods (S is an integer larger than 1) so as to allow the display unit to display information; and
a backlight control unit for controlling a drive of the backlight unit,
wherein in the display unit, (n−1) pixels each provided with a color filter of any of (n−1) colors and a transparent pixel not provided with any color filter are used as the picture element;
the backlight unit is provided with a plurality of light sources comprising at least an n-th light source that emits light of a color other than the (n−1) colors;
the backlight control unit controls a drive for lighting the light sources so that in the S sub-field periods, a first lighting period for lighting the light sources so as to emit white light as the illumination light and a second lighting period for lighting the n-th light source so as to emit light of a color other than the (n−1) colors alternate in two sequential sub-field periods of the S sub-field periods, and
the display control unit operates the (n−1) pixels and the transparent pixel during the first lighting period and operates the transparent pixel during the second lighting period.

2. The display device according to claim 1, wherein in the picture element, the (n−1) pixels and the transparent pixel are modified such that the difference in transmittance between the (n−1) pixels and the transparent pixel is substantially zero.

3. The display device according to claim 2, wherein in the picture element, the second lighting period in which the transparent pixel performs a display operation is set shorter than the first lighting period in which the (n−1) pixels and the transparent pixel perform a display operation.

4. The display device according to claim 2, wherein in the picture element, the area of the transparent pixel is set smaller than the area of any of the (n−1) pixels.

5. The display device according to claim 1, wherein in the picture element, a red pixel and a green pixels provided respectively with a red filter and a green filter are used as the (n−1) pixels; and
in the backlight unit, a red light source and a green light source that respectively emit red light and green light are used as the plurality of light sources other than the n-th light source, and a blue light source that emits blue light is used as the n-th light source.

6. The display device according to claim 1, wherein a liquid crystal panel is used as the display unit.

7. The display device according to claim 1, wherein the light sources are provided to the backlight unit so as to face the display unit.

8. The display device according to claim 1, wherein the backlight unit is provided with a light guide into which light from the light sources enters and that emits the incident light toward the display unit.

9. The display device according to claim 1, wherein light-emitting diodes are used as the light sources.
